(19) United States
(12) Patent Application Publication
(10) Pub. No.: US 2006/0124325 A1
(43) Pub. Date: Jun. 15, 2006

(54) Implement for removing weeds from paviours joints

(76) Inventor: Donald Glanmor Howells, Rushden, Northants (GB)

Correspondence Address: LUCASH, GESMER & UPDEGROVE, LLP, 40 BROAD ST, SUITE 300, BOSTON, MA, 02109, US

(21) Appl. No.: 10/528,394

(22) PCT Filed: Sep. 19, 2003
(86) PCT No.: PCT/GB03/04177

§ 371 Date: Sep. 12, 2005

(30) Foreign Application Priority Data
Sep. 24, 2002 (GB) 0222235.4

(51) Int. Cl. A01B 1/00

(52) U.S. Cl. 172/371

(57) ABSTRACT

An implement for use in removing weeds, moss or other matter from the joints between parviours (P), comprises an elongate handle carrying a blade (12), the blade extending along an axis at an angle of 25° to 65° to the axis of the handle and being formed with an apex at its forward end. The implement is arranged for its handle to be held by a user when standing, with the handle extending forwardly and downwardly from the use and with the apex of the blade engaged in the joint between paviours: the user then draws the implement towards him.

The present invention relates to an implement for use in removing weeds, moss or other matter from the joints between paviours.

Paviours have become popular for driveways, pathways etc. but are prone to the growth of weeds and moss and the accumulation of other matter in the joints between them.

I have now devised an implement which is effective in removing weeds or moss from the joints between paviours.

In accordance with the present invention, there is provided an implement for use in removing weeds, moss or other matter from the joints between paviours, the implement comprising an elongate handle carrying a blade at one end thereof, the blade extending along an axis at an angle of 25 to 65° to the axis of the handle and being formed with an apex at its forward end, said elongate handle permitting the user, when in standing position, to hold the implement by its handle, with said handle inclined downwardly away from the user and said blade extending forwardly at a steeper angle, with said apex of said blade engaged in a joint between paviours, and said blade being bent or folded along its longitudinal axis so that it is V-shaped or dished in cross-section, with its concave side arranged, in use, to face toward the user.

The implement is arranged for its handle to be held by a user when standing, the handle extending forwardly and downwardly from the user with the apex of the blade engaged in a joint between paviours, directed at a steeper angle than the handle, but still slightly forwardly or vertically. The user then draws the implement towards him, drawing the blade along the joint to clear out the weeds, moss or other matter from the joint.

Preferably the blade is formed with a generally rounded apex, to complement the shape of the groove formed at ground level between two paviours, this groove resulting from the chamfered top edges of the paviours. Preferably the rounded end of the blade is further provided with a projecting point, for engaging into the gap between the sides of adjoining paviours.

An embodiment of the present invention will now be described by way of example only and with reference to the accompanying drawings, in which:

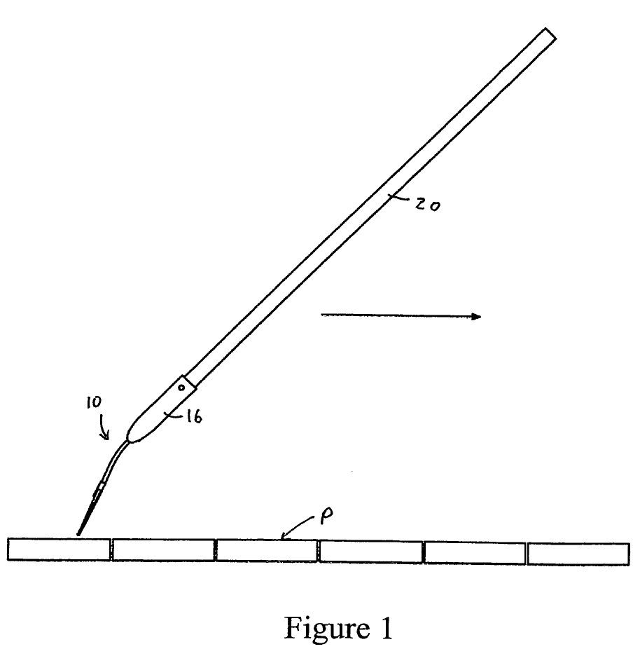

FIG. 1 is a side view of an implement in accordance with the present invention, in use clearing out the weeds from the joints between paviours;

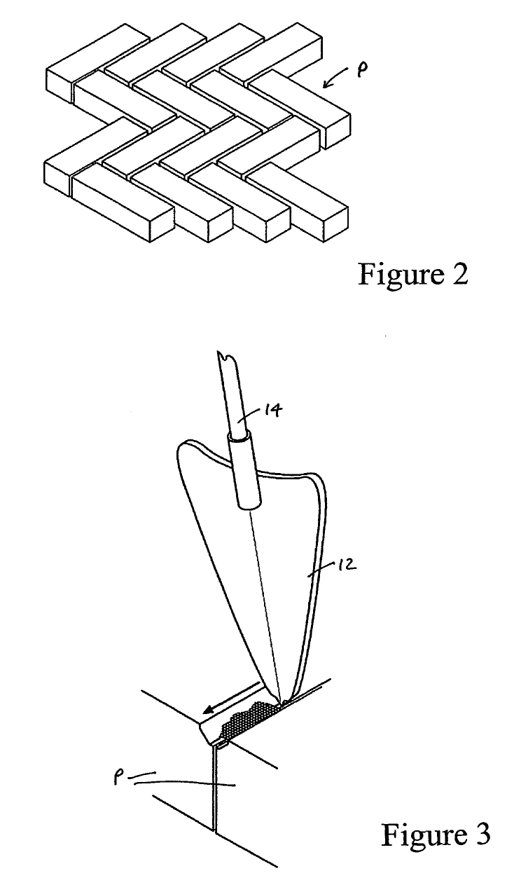

FIG. 2 is a view of a typical area of pathway or driveway made up of paviours;

FIG. 3 is an enlarged view of the head of the implement, shown in the process of clearing out moss from the joint between two paviours;

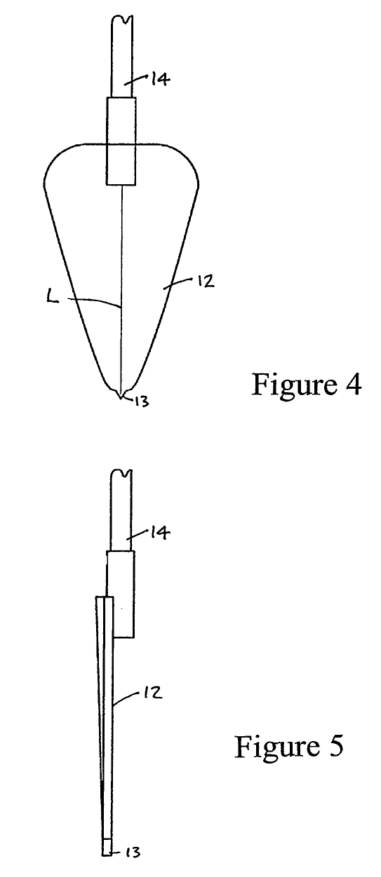

FIG. 4 is a front view of the head of the implement; and

FIG. 5 is a side view of the head of the implement.

Referring to FIG. 1 of the drawings, there is shown a long-handled implement for clearing weeds, moss or other matter from the joints between paviours, the implement comprising a metal head 10 fitted to one end of a straight, elongate handle 20. As shown in FIGS. 4 and 5, the head 10 of the implement comprises a generally triangular-shaped blade 12 extending from one end of a stem 14, the other end of the stem 14 being provided with a socket 16 (FIG. 1) into which the end of the elongate handle 20 is fitted.

The stem 14 of the implement is curved or bent so that the blade 12 is directed at an acute angle to the axis of the handle 20: this angle is in the range of 25 to 65°, preferably in the range 30 to 55° and most preferably in the range 35 to 45°.

The blade 12 of the implement is generally rounded at its apex, but this rounded apex is provided with a triangular-shaped point 13. The blade 12 is also folded along a centre line L through its apex, so as to be slightly V-shaped in cross-section.

In clearing out weed, moss or other matter from the joints between paviours, shown at P in FIGS. 1 and 2, the user, in standing position, holds the implement by its handle 20, with the handle inclined downwardly as shown in FIG. 1 and the apex of the blade 12 of the implement engaged in a joint between the paviours. The handle 20 thus extends forwardly and downwardly from the user at a comfortable angle, typically in the range of 35 to 55° to the horizontal, with the blade 12 of the implement extending forwardly but at a steeper angle, or vertically: in use, preferably the blade lies at an angle of 0 to 10° to the vertical. The user then draws the implement towards him, as indicated by the arrow in FIG. 1, pulling the apex of the blade 12 along the joint, as shown in FIG. 3: no other part of the implement is in contact with the paviours.

The rounded apex of the blade 12 matches the groove formed between two adjacent paviours, owing to their chamfered top edges. Moreover, the pointed tip 13 of the blade engages into the top of the small gap between the two adjoining sides of the two paviours. As a result, the blade 12 serves in an effective manner to clear out weeds, moss or other matter from the joints between the paviours.

Also, because of the angle which the blade 12 makes with the surface of the pathway or driveway, the blade rides easily over joints running transversely to the joint along which the implement is drawn.

1) An implement for use in removing weeds, moss or other matter from the joints between paviours, the implement comprising an elongate handle carrying a blade at one end thereof, the blade extending along an axis at an angle of 25 to 65° to the axis of the handle and being formed with an apex at its forward end, said elongate handle permitting the user, when in standing position, to hold the implement by its handle, with said handle inclined downwardly away from the user and said blade extending forwardly at a steeper angle, with said apex of said blade engaged in a joint between paviours, and said blade being bent or folded along its longitudinal axis so that it is V-shaped or dished in cross-section, with its concave side arranged, in use, to face toward the user.

2) An implement as claimed in claim 1, in which said apex with which said blade is formed is generally rounded.

3) An implement as claimed in claim 2, in which said generally rounded apex of said blade is provided with a projecting point.

4) An implement as claimed in any preceding claim, in which said angle of the blade axis relative to the axis of said handle is in the range of 30 to 55°.

5) An implement as claimed in claim 4, in which said angle of the blade axis relative to the axis of said handle is in the range 35 to 45°.
